(19) United States
(12) Patent Application Publication
(10) Pub. No.: US 2024/0106750 A1
(43) Pub. Date: Mar. 28, 2024

(54) TECHNIQUES FOR MULTI-PATHING OVER RELIABLE PATHS AND COMPLETION REPORTING

(71) Applicant: Intel Corporation, Santa Clara, CA (US)

(72) Inventors: Nayan Amrutlal SUTHAR, Bangalore (IN); Uri ELZUR, San Jose, CA (US); Josh D. COLLIER, Royersford, PA (US)

(21) Appl. No.: 18/537,682

(22) Filed: Dec. 12, 2023

(30) Foreign Application Priority Data
Aug. 1, 2023 (IN) 202341051573

(51) Int. Cl. H04L 45/00; H04L 45/24; H04L 45/42

(52) U.S. Cl. CPC H04L 45/566; H04L 45/24; H04L 45/42

(57) ABSTRACT

Examples include techniques for multipathing over reliable paths and completion reporting. Example techniques include examples of providing reliability over multiple paths routed through a network between a source and a target of a message. Example techniques also include examples of completion reporting for messages sent via packets routed through a network over multiple paths.

### RELATED APPLICATION

This application claims priority from Indian Provisional Patent Application No. 202341051573, entitled “TECHNIQUES FOR MULTI-PATHING OVER RELIABLE PATHS AND COMPLETION REPORTING,” filed Aug. 1, 2023, in the Indian Patent Office. The entire contents of the Indian Provisional Patent Application are incorporated by reference in their entirety.

### TECHNICAL FIELD

Examples described herein are generally related to sending packets associated with a message over multiple paths of network and completion reporting to indicate the message has been received over the multiple paths of the network.

### BACKGROUND

Applications associated with artificial intelligence or machine learning can consume high amounts of data or network bandwidth over a data network such as an Ethernet-based network. These examples of high bandwidth applications may need to use multiple paths through the data network to send a message that includes sending separate flows of packets via respective paths. The multiple paths can be necessary in order to prevent excessive use of a given path that leads to a hotspot in the data network and/or to provide an acceptable level of bandwidth to meet high data consumption demands imposed by these types of high bandwidth applications.

### BRIEF DESCRIPTION OF THE DRAWINGS

FIG. 1 illustrates an example system.

FIG. 2 illustrates first example details of logic implemented by circuitry at network interface controllers of the system.

FIG. 3 illustrates an example first logic flow.

FIG. 4 illustrates an example second logic flow.

FIG. 5 illustrates example details of logic implemented by circuitry at network interface controllers of the system.

FIG. 6 illustrates an example first process.

FIG. 7 illustrates an example second process.

FIG. 8 illustrates an example compute server system.

### DETAILED DESCRIPTION

A data stream can be a sequence of packets that have an application-level relationship to convey information. A flow for a data stream can be a set of related packets that have a common identification derived from a set of header fields. For Internet protocol (IP) traffic, typically, a combination of the source IP address, destination IP address, a protocol field, a source port number, and a destination port number are used to identify a flow. In some examples, a set of fields used to identify a flow for a data stream can be referred to as “n-tuple”. A packet in a flow for a data stream is expected to have the same set of tuples in the packet header. A packet in a flow for a data stream, in order to be controlled, can be identified by a combination of tuples (e.g., Ethernet type field, source and/or destination IP address, source and/or destination User Datagram Protocol (UDP) ports, source/destination transmission control protocol (TCP) ports, or any other header field) and a unique source and destination queue pair (QP) number or identifier. In typical Ethernet+IP networks packets of a given flow for a data stream can travel over a single path and in order.

A 5-tuple example for a packet in a flow for a data stream can include source IP address, source port, destination IP address, destination port or a transport protocol (e.g., UDP or TCP). Generically, an n-tuple can include data from a link layer (e.g., Ethernet), network layer (e.g., IP), transport layer (e.g., TCP,UDP), upper layer protocol (e.g., remote direct memory access (RDMA) over an Ethernet network (RoCE), Internet Wide-Area RDMA Protocol (iWARP), quick UDP internet connections (QUIC), InfiniBand over Ethernet (IBoE), hypertext transfer protocol (HTTP), rate control protocol (RCP), identify-aware proxy (TAP), interplanetary file system (IPFS)). Also, distinctions of different types of n-tuples can include, but are not limited to, Ethertype, RDMA queue pair, RDMA source and destination group identifier (GID), RoCE or InfiniBand local route headers (LRH), and global route headers (GRH), local route headers, global route headers or FlowLabels. Also, in some examples for RDMA-related n-tuples, a GID can uniquely identify a network interface. For these examples, a GID can be a 16-byte value that includes two parts. The first part of the GID, the higher 64 bits, can be a subnet prefix. The second part of the GID can include a unique subnet ID (e.g., a globally unique device ID (GUID).

Network interfaces or network interface controllers coupled to a data network usually send a data stream as a single flow. One function of transport protocols utilized to send the data stream can be to ensure reliable delivery of packets included in the data stream. In some examples, a go-back-N protocol can be used to provide reliability for delivery of the packets. For example, the InfiniBand® Trade Association (IBTA) maintains the InfiniBand™ specifications and the RoCE and iWARP specifications. These specification describe the use of go-back-N protocols that can exploit a property of a data network that can ensure that packets of a given flow for a data stream are sent over a single path and are delivered in a same order as sent from a source. Also, acknowledgments can also be delivered in order to facilitate detection of possible loss of a packet (e.g., any out of order packet indicate packet loss).

Emerging applications such as those associated with AI, machine learning or deep learning can require high network bandwidth and a single port or single path through a data network (e.g., Ethernet+IP network) may not be adequate enough to meet these high network bandwidth requirements. The use of multiple paths to send separate flows of packets of a data stream transmitted or to be received by these types of applications can lead to an out of order delivery of the packets. The out of order delivery of the packets does not necessarily indicate packet loss and use of go-back-N protocols may therefore not work for multi-path routing of packets.

In some examples, reliability over multiple paths to send separate flows of packets of a data stream can be provided via techniques associated with TCP, multi-path transport RDMA in datacenters. These techniques associated with TCP, multi-path transport RDMA in datacenters can include adding incremental sequence numbers in headers of packets included in a sequence of packets of a data stream. Packets of the data stream can then be sprayed/sent on a plurality of paths of a datacenter network to create sub-streams. This is achieved by selecting a different n-tuple for each sub-stream (typically a different source/transmit port can be used for each path), effectively creating one flow for each sub-stream. Circuitry at a source/initiator network interface controller can execute logic that is responsible for assigning different paths for each sub-stream. Different algorithms can be used to decide which packet goes on which path (e.g. round robin). Packets on a given path arrive in order at a target/responder destination. Different paths will likely have different delays through the datacenter network. Therefore, packets travelling on different paths may arrive out of order. In some implementations, sub-streams are reassembled at the target/responder to recreate the original order and then sequence numbers are checked. In other implementations, sub-streams are simply merged and detection of a lost packet requires tracking each individual packet and mechanisms like a sliding window protocol (used in TCP) can be required. The target/responder receiver can be required to track a potentially out-of-order arrival of all packets in a window. The source/initiator transmitter can be required to limit a number of in-flight packets to a size of the window that the target/responder receiver can track. Both of these implementations add a substantial amount of complexity at the target/responder to track in-flight packets. Also, the amount of state required is relatively high for this type of tracking to maintain reliability while using multiple paths to route packets of a message.

As mentioned above, use of multiple paths to send separate flows of packets of a data stream transmitted or to be received by emerging applications associated with AI, machine learning or deep learning can lead to an out of order delivery of the packets. Typically, the network carries messages that are made up of one or more packets. If the packets arrive out of order, then detecting the end of a message at the receiver becomes problematic. The receiver needs to ensure that all packets of a message are received and are globally observable (GO) before a notification of completion is provided to the receiving application that requested at least the data associated with the message.

As described in this disclosure, multi-pathing (distributing a data stream over multiple paths) can be done for transmitting packets of a message on data paths on which reliability is independently achieved, versus trying to achieve reliability over multiple data paths combined. The complexity of this multi-pathing solution can be substantially lower. In some examples, there can be no need to track and reorder out of order packets (arising due to multiple paths) to achieve reliability. Achieving reliability over individual paths where packets are in order can be much simpler. Also, example completion reporting techniques for messages that can involve out of order packets received for the data stream over the multiple paths can include tracking received acknowledgements sent from a target at the source to infer completion of receipt of packets of the message and then notify the target with an additional packet indicating message completion. The example completion reporting techniques can also involve a simplified tracking mechanism at the target to count packets received to infer completion based on information included in at least some of the packets of a message. These examples can reduce complexity of source or target hardware and reduce latency of completion reporting. Complexity reduction comes with the usual benefits of risk reduction, faster convergence of design, and lower cost. Reduced latency for completion reporting leads to performance improvement to latency sensitive applications such as those associated with AI, deep learning or machine learning.

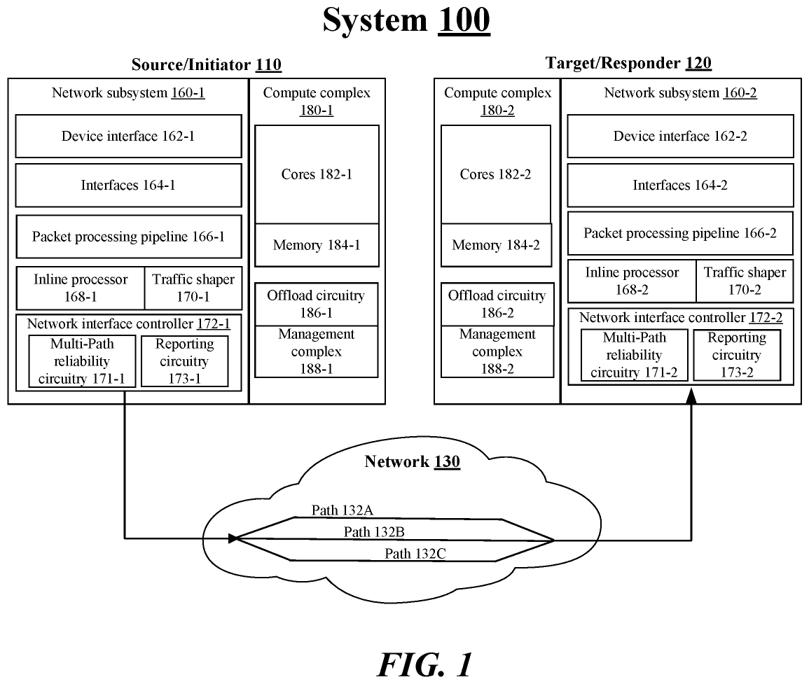

FIG. 1 depicts an example system 100. In some examples, as shown in FIG. 1, system 100 include a source/initiator 110 and a target/responder 120 communicatively coupled together through a network 130. For these examples, source/initiator 110 or target/responder 120 can support emerging applications such as those associated with AI, machine learning or deep learning (not shown) that can require high network bandwidth through network 130 that can cause packets routed from source/initiator 110 to target/responder 120 to be sprayed/sent over multiple paths 132A, 132B, or 132C (examples are not limited to 3 paths to route packets).

As shown in FIG. 1, source/initiator 110 and target/responder 120 include respective network subsystems 160-1 and 160-2 that can be communicatively coupled to compute complexes 180-1 and 180-2. In some example, device interfaces 162-1 and 162-2 can provide an interface to communicate with respective hosts of source/initiator 110 and target/responder 120. Various examples of device interfaces 162-1 or 162-2 can utilize protocols based on Peripheral Component Interconnect Express (PCIe), Compute Express Link (CXL), or other protocols as such as protocols associated with virtual device interfaces.

According to some examples, interfaces 164-1 or 164-2 can be arranged to initiate and terminate at least offloaded RDMA operations, non-volatile memory express (NVMe) reads or writes operations, and local access network (LAN) operations. Also, in some examples, packet processing pipelines 166-1 or 166-2 can perform packet processing (e.g., packet header and/or packet payload) based, at least in part, on respective configurations, support of quality of service (QoS) and telemetry reporting. Packet processing pipelines 166-1 or 166-2 (e.g., comprised of one or more application specific integrated circuits (ASICs), field programmable gate arrays (FPGAs), or other circuitry) can be arranged to perform lookup of tables stored in internal memory (e.g., memory 184-1 or 184-2) and/or external memory. Inline processors 168-1 or 168-2 can be arranged to perform offloaded encryption or decryption of packet communications (e.g., Internet Protocol Security (IPSec) or others). Traffic shapers 170-1 or 170-2 can be arranged to schedule transmission of communications.

In some example, network interface controllers 172-1 and 172-2 can be arranged to provide separate interfaces at least to an Ethernet network (e.g., network 130) via implementation of media access control (MAC) and serializer/de-serializer (Serdes) operations. Also, as shown in FIG. 1, network interface controllers 172-1 and 172-2 include multi-path reliability circuitry 171-1, 171-2 and reporting circuitry 173-1, 173-2. As described in more detail below, multi-path reliability circuitry 171-1 and 171-2 can include logic and/or features to achieve reliability over multiple data paths routed through a network such as network 130 (e.g., from among paths 132A-C). Also, as described in more detail below, reporting circuitry 173-1 and 173-2 can include logic and/or features to implement example completion reporting techniques for messages sent via packets routed through a network such as network 130 over multiple data paths that could result in the packets of the message arriving out of order.

According to some examples, cores 182-1 or 182-2 can be configured to perform infrastructure operations such as storage initiator, transport layer security (TLS) proxy, virtual switch (e.g., vSwitch), or other operations. Memory 184-1 or 184-2 can be arranged to store applications and data to be performed or processed. Offload circuitry 186-1 or 186-2 can be arranged to perform at least cryptographic and compression operations (e.g., for respective hosts or for use by respective compute complexes 180-1 and 180-2. Management complex 188-1 or 188-2 can perform secure boot, life cycle management and management of respective network subsystems 160-1 and 160-2 and/or respective compute complexes 180-1 and 180-2.

A packet may refer to various formatted collections of bits that may be sent across a network, such as Ethernet frames, Internet Protocol (IP) packets, Transmission Control Protocol (TCP) segments, User Datagram Protocol (UDP) datagrams, RDMA formatted packets, etc. For example, a packet can include one or more headers and a payload and encapsulate one or more packets having headers and/or payloads. One or more headers can include one or more of: Ethernet header, IP header, TCP header, UDP header, InfiniBand Trade Association (IBTA) header, or RDMA header. A header can be used to control a flow of the packet through a network to a destination. A header can include information related to addressing, routing, and protocol version. For example, an IP header can include information about the version of the IP protocol, the length of the header, the type of service used, the packet's Time to Live (TTL), the source and destination address. For example, a header can include n-tuple information such as source address, destination address, IP protocol, transport layer source port, and/or destination port.

According to some examples, for a packet, packet processing pipelines 166-1 or 166-2 can perform context aware routing based on at least two inputs: a preface metadata and destination address. Preface metadata can include a virtual network identifier (VNI) or tunnel identifier associated with the packet. A VNI can represent a VXLAN tunnel identifier for a tenant and can map to multiple sender virtual machines (VMs), containers, applications, services, or others within respective host systems. A destination address can include at least IPv4 address (e.g., 32b) or IPv6 address (128b). A routing table can store a list of inputs and lookup results. Lookup results can include one or more of: a next hop address, output port, and/or other action to perform on the packet. A set of actions to perform on the packet can include at least: sending the packet to a particular egress port, modifying one or more packet header field values, dropping the packet, mirroring the packet to a mirror buffer, etc.

In some examples, cores 182-1 or 182-2 can represent processing cores included in various commercially available processors. The various commercially available processors can include, but are not limited to, processors commercially available from Intel®, ARM®, AMD®, Qualcomm®, IBM®, Nvidia®, Broadcom®, Texas Instruments®, among others.

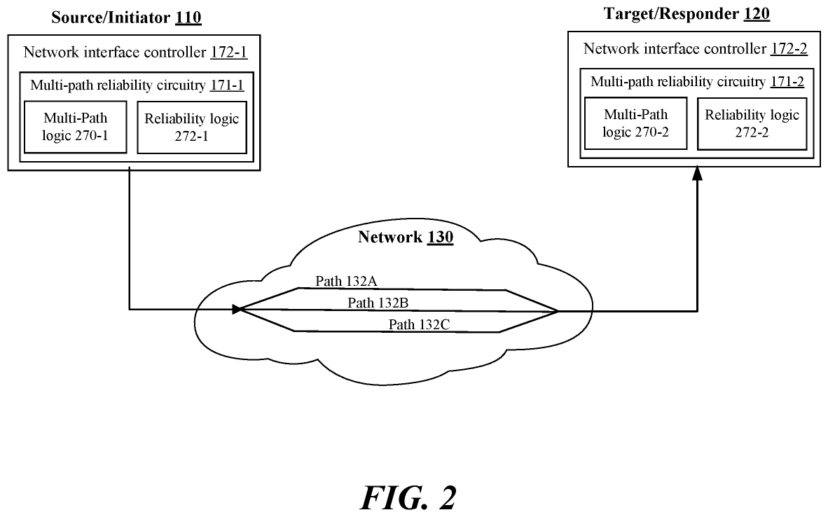

FIG. 2 illustrates example details of features and/or logic implemented by multi-path reliability circuitry 171-1 at network interface controller 172-1 of source/initiator 110 or multi-path circuitry 171-2 at network interface controller 172-2 of target/responder 120. Multi-path reliability circuitry 171-1 or 171-2 can be an ASIC, an FPGA, processor circuit, or a portion of an ASIC, FPGA or processor circuit (e.g., resident on or maintained at respective network interface controllers 172-1 and 172-2). In some examples, as shown in FIG. 2, multi-path reliability circuitry 171-1 and 171-2 include multi-path logic 270-1/270-2 and reliability logic 272-1/272-2.

According to some examples, multi-path logic 270-1 and reliability logic 272-1 at source/initiator 110 can implement techniques to provide multi-path reliability for transmitting packets of a message sent via multiple data paths through a network such as network 130 via at least two paths included in paths 132A-C to target/responder 120 (examples not limited to 3 paths, any number of paths are contemplated). For these examples, the message can be included in a data stream composed of a plurality of packets for eventual consumption by an application at target/responder 120. Multi-path logic 270-1 can be configured to cause packets of the message to be sprayed/sent over a set of data paths included in paths 132A-C to create multiple sub-streams of the data stream. According to some examples, the multiple sub-streams could be achieved by multi-path logic 270-1 selecting a different n-tuple for each sub-stream of the data stream. For example, use of different source ports (not shown) of network interface 172-1 at source/initiator 110 to route each sub-stream via paths 132A-C that can be respectively coupled with the different source ports for respective sub-streams. Selecting a different n-tuple for respective sub-streams can effectively create one flow for each sub-stream of the data stream. Reliability logic 272-1 can be configured to add incremental sequence number to headers of packets included in individual sub-streams of the data stream. Multi-path logic 270-1 can cause packets of each sub-stream to follow a fixed path through network 130 to reach target/responder 120. For example, packets of a first sub-stream follow a first fixed path through a first source port coupled with path 132A, packets of a second sub-stream follow a second fixed path through a second source port coupled with path 132B and packets of a third sub-stream follow a third fixed path through a third source port couple with path 132C. Multi-path logic 270-1 can also cause sub-streams to follow different paths based on a given network configuration of network 130. Adding incremental sequence numbers to packets included in individual sub-streams and spraying/sending packets of sub-streams via respective fixed paths can result in independently achieved reliability on each path through network 130.

According to some examples, as mentioned above, packets of respective sub-streams follow a fixed path through network 130 and different paths can be determined based on a given network configuration of network 130. For these examples, at target/responder 120, reliability logic 722-2 of multi-path reliability circuitry 171-2 can be configured to perform a sequence number check of received sub-streams sent through paths 132A-C. If a given sub-stream has a missing sequence number, that can indicate loss of a packet of that given sub-stream and a retransmission of that packet or the entire sub-stream can be requested. If no sequence numbers are missing, following the sequence number checks of received sub-streams, multi-path logic 270-2 of multi-path reliability circuitry 171-2 can be configured to merge the sub-streams to recreate or reform the data stream for the message. Once merged, the packets and associated data payloads can be ready for consumption (e.g., by an application). This sequence checking of sub-streams followed by merging the sub-streams significantly reduces complexity at network interface controller 172-2 compared to other multi-path reliability techniques such as techniques associated with TCP, multi-path transport for RDMA in datacenters. Techniques associated with TCP, multi-path transport for RDMA in datacenters includes creating a single sequence of numbers across packets in all sub-streams and utilizing a tracking window to track potentially out-of-order arrival of packets. The recombining of all packets to check a single sequence and tracking in-flight packets that may be out-of-order would require additional buffer compacity at target/responder 120 and additional circuitry to implement the tracking while utilizing the tracking window.

According to some examples, merging of sub-streams of a data stream at target/responder 120 that were received via paths 132A-C can lead to the data stream having out-of-order packets due to possible variations in path transmit times for these paths through network 130. For data streams associated with some applications, a header of an individual packet included in a data stream can have enough information to enable data of the packet to be consumed independent of other packets in the data stream (e.g., formatted as RDMA packets that include memory address pointers to where a data payload can be written at a target/responder). For these examples, out-of-order packets are acceptable. In cases where out-of-order packets are not acceptable to an application, mechanisms such as a re-order buffer (not shown) at or accessible to network interface controller 172-2 can be used to facilitate a re-ordering of packets prior to causing packet payloads to be placed to system memory (e.g., memory 184-2) and then made available for consumption by the application.

According to some examples, if one of a source/initiator or a target/responder do not support use of sub-stream specific sequence numbers in individual sub-streams of a data stream of a message transmitted over multiple paths, this feature can be turned off. The feature can then be subsequently turned back on if both sending and receiving sides of a data stream are configured to support the use of sub-stream specific sequence numbers to provide multi-path reliability.

Included herein are logic flows related to system 100 that can be representative of example methodologies for providing multi-path reliability for transmitting packets of a message sent and received via multiple data paths through a network to a target/responder. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a logic flow can be implemented by computer executable instructions stored on at least one non-transitory computer readable medium or machine readable medium, such as an optical, magnetic or semiconductor storage. The embodiments are not limited in this context.

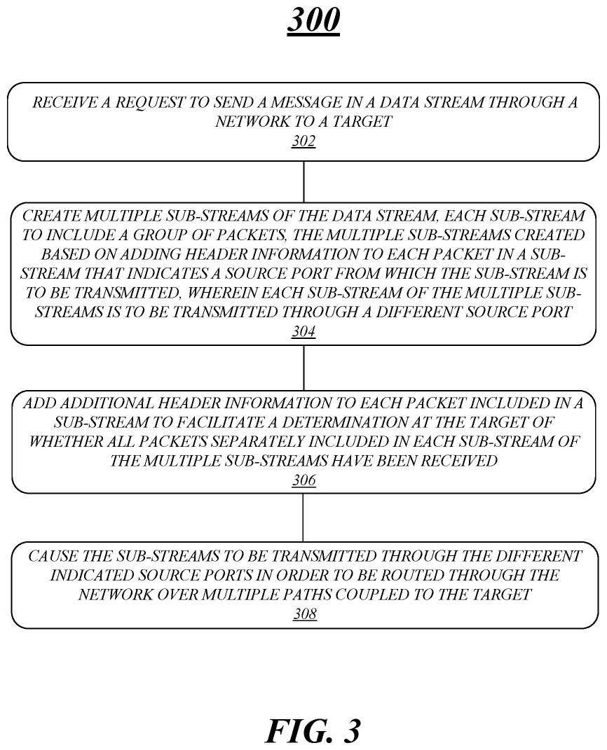

FIG. 3 illustrates an example logic flow 300. In some examples, logic flow 300 can represent a process flow to provide multi-path reliability for transmitting packets of a message sent via multiple data paths through a network to a target/responder. For these examples, elements of system 100 as shown in FIG. 1, can be related to logic flow 300. These elements of system 100 can include elements of source/initiator 110, network interface controller 172-1, and logic and/or features of multi-path reliability circuitry 171-1 such as multi-path logic 270-1 or reliability logic 272-1 as shown in FIG. 2. Example logic flow 300 is not limited to implementations using elements of system 100 shown in FIG. 1 or the logic and/or features of multi-path reliability circuitry 171-1 shown in FIG. 2.

In some examples, at 302, logic flow 300 can receive a request to send a message in a data stream through a network to a target. For these examples, logic and/or features of multi-path reliability circuitry 171-1 of network interface controller 172-1 at source/initiator 110 such as multi-path logic 270-1 can receive the request to send the message.

According to some examples, at 304, logic flow 300 can create multiple sub-streams of the data stream, sub-streams of the multiple sub-streams to separately include a group of packets, the multiple sub-streams created based on adding header information to packets of a sub-stream that indicate a source port from which the sub-stream is to be transmitted, sub-streams of the multiple sub-streams are to be transmitted through different source ports. For these examples, multi-path logic 270-1 can create the multiple sub-streams.

In some examples, at 306, logic flow 300 can add additional header information to packets of a sub-stream to facilitate a determination at the target of whether packets included in the sub-streams of the multiple sub-streams have been received. For these examples, logic and/or features of multi-path reliability circuitry 171-1 such as reliability logic 272-1 can add the additional header information.

According to some examples, at 308, logic flow 300 can cause the sub-streams to be transmitted through the different indicated source ports in order to route the sub-streams through the network over multiple paths coupled to the target. For these examples, multi-path logic 270-1 can cause the sub-streams to be transmitted through the different indicated source ports.

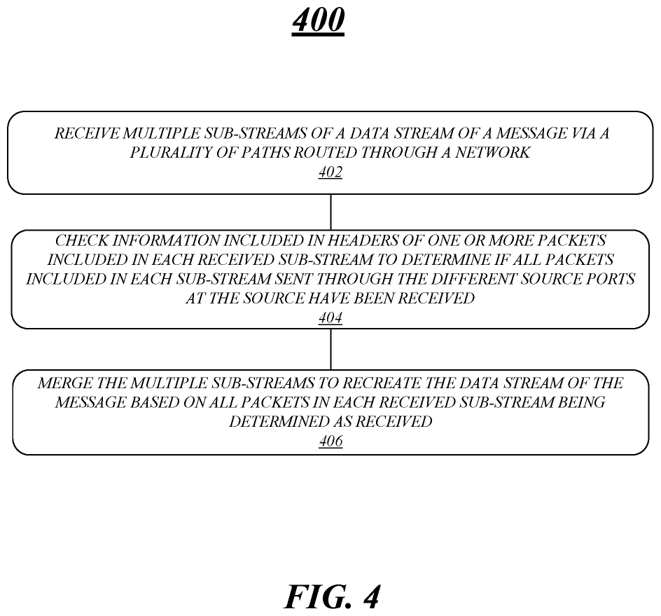

FIG. 4 illustrates an example logic flow 400. In some examples, logic flow 400 can represent a process flow for receiving, at a target/responder, packets of individual sub-streams sent via multiple data paths through a network and ensuring multi-path reliability via sequence checking of sequence numbers added to packets of the individual sub-streams. For these examples, elements of system 100 as shown in FIG. 1, can be related to logic flow 400. These elements of system 100 can include elements of target/responder 120, network interface controller 172-2, and logic and/or features of multi-path reliability circuitry 171-2 such as multi-path logic 270-2 or reliability logic 272-2 as shown in FIG. 2. Example logic flow 400 is not limited to implementations using elements of system 100 shown in FIG. 1 or the logic and/or features of multi-path reliability circuitry 171-2 shown in FIG. 2.

According to some examples, at 402, logic flow 400 can receive multiple sub-streams of a data stream of a message via a plurality of paths routed through a network. For these examples, logic and/or features of multi-path reliability circuitry 171-2 of network interface controller 172-2 at target/responder 120 such as multi-path logic 270-2 can receive the multiple sub-streams via paths 132A-C of network 130 coupled with source/initiator 110. In some examples, sub-streams can be sent through different source ports at a source of the message, the different source ports coupled with different paths from among the plurality of paths.

In some examples, at 404, logic flow 400 can check information included in headers of one or more packets included in the multiple sub-streams to determine if packets included in respective sub-streams have been received, the checked information to include sub-stream specific sequence numbers. For these examples, logic and/or features of multi-path circuitry 271-2 such as reliability logic 272-2 can check the information included in the headers to determine if packets have been received.

According to some examples, at 406, logic flow 400 can merge the multiple sub-streams to recreate the data stream of the message based on packets in respective sub-streams of the multiple sub-streams being determined as received. For these examples, multi-path circuitry 270-2 can cause the multiple sub-streams to be merged to recreate the data stream of the message.

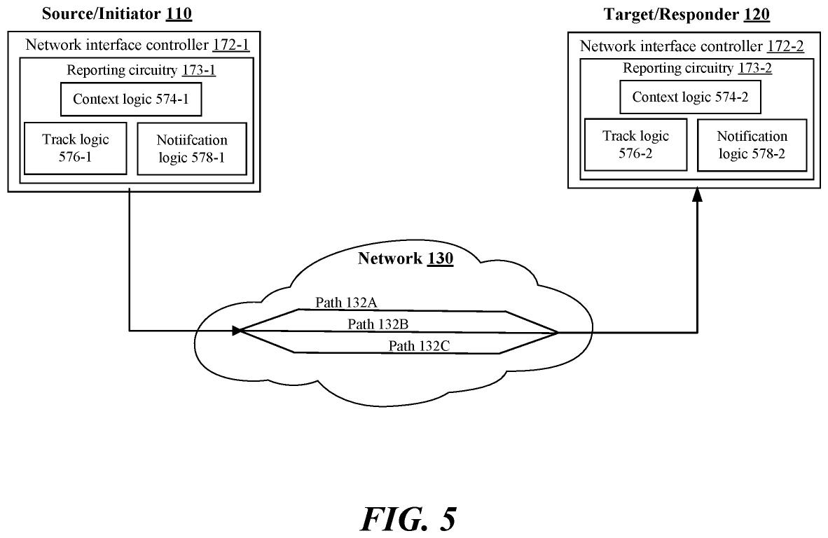

FIG. 5 illustrates example details features and/or logic implemented by reporting circuitry 171-1 at network interface controller 172-1 of source/initiator 110 or reporting circuitry 171-2 at network interface controller 172-2 of target/responder 120. Reporting circuitry 171-1 or 171-2 can be an ASIC, an FPGA, processor circuit, or a portion of an ASIC, FPGA or processor circuit (e.g., resident on or maintained at respective network interface controllers 172-1 and 172-2). In some examples, as shown in FIG. 5, reporting circuitry 171-1 and 171-2 includes context logic 574-1/574-2, track logic 576-1/576-2 and notification logic 578-1/578-2.

According to some examples, depending on a choice of implementation for spraying/sending packets of a message via paths 132A-C of network 130 to target/responder 120, packets sent via different paths (e.g., in sub-streams) can arrive at target/responder 120 out of order. For these examples, detecting an end of a message having out-of-order packets received at target/responder 120 can be problematic. In some examples, target/responder 120 can ensure that packets of a message are received and are globally observable before a notification is to be provided to an application targeted to receive the message. If a strict order in which the packets were sent is maintained, then a message completion notification could be provided upon receipt of the last packet in a message. However, as mentioned above, use of multiple paths can result in out-of-order packets and in an example where strict order is based on sequence numbers attached to individual packets, the last packet in a sequence may not indicate complete receipt of packets of the message.

According to some examples, logic and/or features of reporting circuitry 173-1 such as track logic 576-1 or notification logic 578-1 can be configured to implement techniques for source tracking and completion notifications associated with messages having packets that are sent over multiple paths through network 130 to reach target/responder 120. For these examples, a request for source/initiator 110 to send packets of a message can originate from an application at target/responder 120. Responsive to the request, packets of the message can be sprayed/sent over multiple paths included in paths 132A-C routed through network 130 to reach target/responder 120. For example, multi-path logic 270-1 shown in FIG. 2 and described above can cause the packets of the message to be sprayed/sent over the multiple paths to reach target/responder 120. Also, as at least one packet or a group of packets are received at target/responder 120 via a destination port of network interface controller 172-2 coupled with one of path 132A-C, logic and/or features of reporting circuitry 173-2 such as notification logic 578-2 can be configured to send acknowledgements back to source/Initiator 110. Respective acknowledgements, for example, may be routed back via a same path via which the at least one packet or group of packets (e.g., included in a sub-stream) were received. For similar reasons as mentioned above, packets of the message sent responsive to the request and corresponding acknowledgements can arrive out of order at target/responder 120 or source/initiator 110 as the packets of the message and corresponding acknowledgements for received packets in the message are routed via multiple paths. As a result, the last packet of a message sent from source/initiator 110 may not correspond to a last acknowledgment received from target/responder 120.

In order to address the possibility of a last acknowledgement received at source/initiator 110 not corresponding to a last packet of a message sent from source/initiator 110, according to some examples, logic and/or features of reporting circuitry 173-1 such as track logic 576-1 can track receipt of acknowledgements corresponding to each requested transmission of at least one packet or a group of packets of a message from source/initiator 110 to target/responder 120. The at least one packet or group of packets of the message and corresponding acknowledgements to be transmitted through network 130 via paths 132A-C responsive to a request, for example, originating from an application at target/responder 120. Track logic 576-1, in one example, can receive an indication from logic and/or features of multi-path reliability circuitry 171-1 such as multi-path logic 270-1 of an expected total number of acknowledgements to be received based a total number of requested transmissions of at least one packet or a group of packets from source/initiator 110 to target/responder 120 via paths 132A-C. For example, if track logic 576-1 receives an indication from multi-path logic 270-1 that a total of 30 acknowledgements are expected from target/responder 120 for packets of a message, track logic 576-1 can increment a counter for respectively received acknowledgements from target/responder 120 for the message until the count reaches 30. Track logic 576-1 can then cause notification logic 578-1 to generate and send a completion message to target/responder 120 via network 130 to indicate that transmission of the message has been completed. In some examples, logic and/or features of reporting circuitry 173-2 at network interface controller 172-2 of target/responder 120 such as notification logic 578-2, responsive to receipt of the completion message from source/initiator 110, can then cause a completion notification message to be sent to the application at target/responder 120 that was the source of the request to receive the message.

An advantage of source tracking of acknowledgements at source/initiator 110 to determine completion of sending a message is that complexity at the target/responder 120 can be significantly reduced as target/responder 120 does not have to track possibly out-of-order packets to determine when packets of a message are received. A possible disadvantage of source tracking can be attributed to increased latency for an additional roundtrip through network 130 caused by source/initiator 110 having to wait for the final acknowledgement from target/responder 120 before sending a completion message.

According to some examples, logic and/or features at target/responder 120 such as context logic 574-2, track logic 576-2 or notification logic 578-2 can be configured to ensure that packets of a message are received and are globally observable before a notification is to be provided to an application targeted to receive the message. So rather than tracking acknowledgements at source/initiator 110, as described above, receipt of packets of the message are tracked at target/responder 120. For these examples, logic and/or features at source/initiator 110 such as track logic 576-1 can be configured to first add information to respective packet headers to allow for either an explicit packet count mechanism or an implicit packet count mechanism at target/responder 120 to be conducted. Added information for an explicit packet count mechanism can include, but is not limited to, a unique message identifier (ID) for the message, a unique packet ID for individual packets of the message and a total number of packets for the message. Added information for an implicit packet count mechanism can include, but is not limited to, a unique message ID for the message, a unique packet ID for individual packets of the message and a requirement that at least one of the packets of the message has information to indicate a total packet count for the message.

In examples using an explicit packet count mechanism, logic and/or features of reporting circuitry 173-2 at target/responder 120 such as context logic 574-2 can be configured to maintain a context for each partially received message. For these examples, the message context can contain a counter. When a first packet of a new message is received at target/responder 120 via a destination port from among multiple destination ports of network interface controller 172-2 coupled with one of paths 132A-C routed through network 130 (not necessarily the first packet that was transmitted from source/initiator 110), a new message context can be associated with a message ID included in the received first packet. Responsive to successful reception of packets having the same message ID, a packet counter of the message context can be incremented by logic and/or features at reporting circuitry 173-2 at target/responder 120 such as track logic 576-2. When track logic 576-2 determines that the count of received packets matches the total number of packets indicated in each packet, logic and/or features at reporting circuitry 173-2 at target/responder 120 such as notification logic 578-2 can be made aware of the count matching the total number of packets. In some examples, responsive to being made aware of the match, notification logic 578-2 determines that data included in data payloads of the received packets is globally observable (e.g., have been stored to system memory at target/responder 120), a completion notification can then be sent to an application targeted to receive the message.

In examples using an implicit packet count mechanism, context logic 574-2 can be configured to maintain a context for each partially received message. For these examples, the message context can contain a counter. When a first packet of a new message is received at target/responder 120 via a destination port from among multiple destination ports of network interface controller 172-2 coupled with one of paths 132A-C routed through network 130 (not necessarily the first packet that was transmitted from source/initiator 110), a new message context can be associated with a message ID included in the received first packet. Responsive to successful reception of packets having the same message ID, a packet counter of the message context can be incremented by logic and/or features at reporting circuitry 173-2 at target/responder 120 such as track logic 576-2. For these examples of an implicit packet count mechanism, track logic 576-2 needs to identify the packet that indicates the total packet count and then use that total packet count for comparison to the count of received packets. Once track logic 576-2 determines that the count matches the total number of packets indicated in the at least one packet, logic and/or features at reporting circuitry 173-2 at target/responder 120 such as notification logic 578-2 can be made aware of the count matching the total number of packets. In some examples, responsive to be made aware of the match, notification logic 578-2 determines that data included in data payloads of the received packets is globally observable (e.g., have been stored to system memory at target/responder 120), a completion notification can then be sent to an application targeted to receive the message.

Use of an explicit packet count mechanism or an implicit packet count mechanism can present implementation trade-offs. The explicit packet count mechanism can require more space in packets of a message. The implicit packet count mechanism can need more space in a context created at target/responder 120 (e.g., by context logic 574-2). An advantage of either the explicit packet count mechanism or the implicit packet count mechanism compared to techniques that can require a reordering of packets of the message is a lower cost as reordering buffers are not needed to determine that a last packet of a message has been received at target/responder 120. An advantage of either the explicit packet count mechanism or the implicit packet count mechanism compared to tracking completions at the source/initiator 110 can be reduced latency for reporting message completion to the application. However, the complexity associated with target/responder 120 doing the tracking for message completion is relatively higher than the complexity associated with source/initiator 110 doing the tracking for message completion.

According to some examples, if one of a source/initiator or a target/responder do not support message completion features at the source or at the target for a message transmitted over multiple paths through a network, these message completion features can be turned off. The message completion features can then be subsequently turned back on if both sending and receiving sides of a message are configured to support message completion features at the source or at the target.

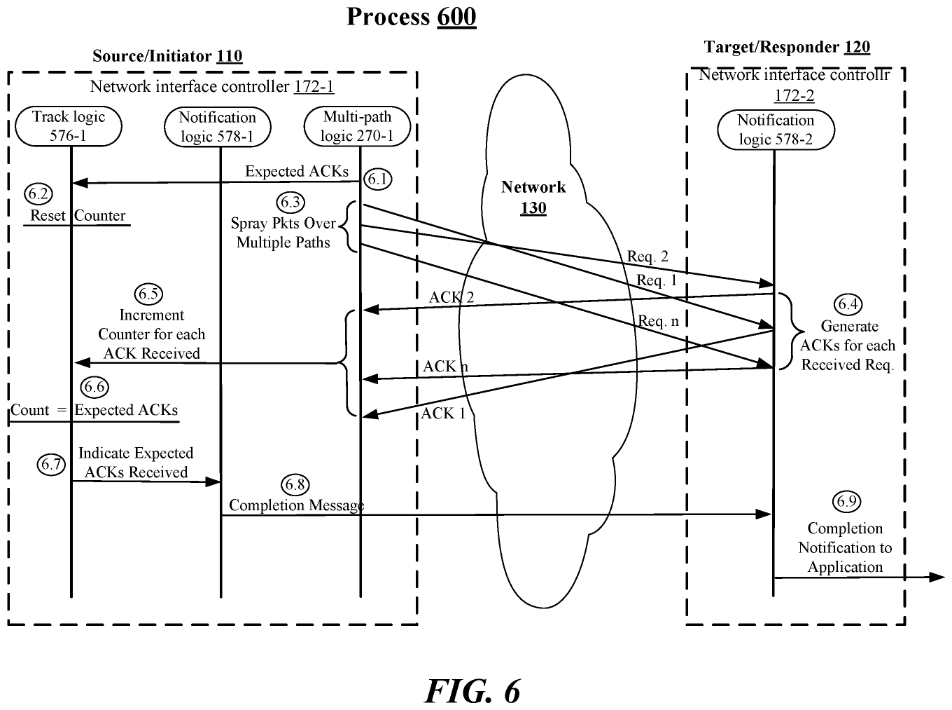

FIG. 6 illustrates an example process 600. In some examples, process 600 can represent techniques for source tracking and completion notifications associated with messages having packets that are sprayed or sent over multiple paths through a network to reach a target/responder. For these examples, elements of system 100 as shown in FIG. 1 or 5, can be related to process 600. These elements of system 100 can include source/initiator 110, network interface controller 172-1 and logic supported by circuitry at network interface controller 172-1 such as, but not limited to, track logic 576-1, notification logic 578-1, or multi-path logic 270. The elements of system 100 can also include network 130, target/responder 120, network interface controller 172-2 and logic supported by circuitry at network interface controller 172-2 such as, but not limited to, notification logic 578-2. However, example process flow 600 is not limited to implementations using elements of system 100 shown in FIG. 1 or 5.

According to some examples, at 6.1 (Expected ACKs), responsive to a request for source/initiator 110 to send packets of a message to target/responder 120 (e.g., originating from an application at target/responder 120), multi-packet logic 270-1 can first determine how the packets of the message are to be sprayed over multiple paths through network 130 to reach target/responder 120 and determines a number of expected acknowledgements (ACKs) to be received. For example, if multi-packet logic 270-1 groups the packets in 3 sub-streams to be sent over 3 paths through network 130, then at least 3 ACKs can be expected. In another example, expected ACKs can be based on a total number of packets transmitted under an expectation that an ACK can be sent for each received packet at target/responder 120. As shown in FIG. 6, multi-path logic 270-1 sends expected ACKs to track logic 576-1.

In some examples, at 6.2 (Reset Counter), track logic 576-1 can reset a counter for use to track ACKs received back from target/responder 120 for the message.

According to some examples, at 6.3, (Spray Pkts Over Multiple Paths), multi-path logic 270-1 can cause packets of the message to be sprayed or sent over multiple paths coupled with multiple source ports of network interface controller 172-1 that are routed through network 130 (e.g., over paths 132A-C) to target/responder 120. For these examples, as shown in FIG. 6, Req. 1, Req. 2 and Req. n, where “n” represents any whole integer >2, can represent at least one packet or a sub-stream/group of packets transmitted from source/initiator 110 over the multiple paths routed through network 130. Also, Req. 1, Req. 2 to Req. n can each represent a sequential ordering of all packets in the message. In other words, packet(s) in Req. 1 can be at the beginning of the sequence and packet(s) in Req. n would be at the end of the sequence.

In some examples, at 6.4 (Generate ACKs for Received Req.), responsive to each received Req., notification logic 578-2 of network interface controller 172-2 at target/responder 120 can generate and/or cause an ACK to be sent to source initiator 110. For these examples, the separate ACKs can be sent on the same path via which a Req. was received. For example, ACK 1 is sent over the same path as Req. 1. According to some examples, the path used to route Req. 1 can cause a delay that results in Req. 2 being received before/out of order compared to receipt of Req. 1. Consequently, due to possibly the same reasons for the delay of receipt of Req. 1, a corresponding ACK 1 can be delayed and can arrive out of order compared to ACK 2 and ACK n as shown in FIG. 6.

According to some examples, at 6.5 (Increment Counter for ACK Received), track logic 576-1 can be arranged to observe each ACK received from target/responder 120 for the message and then increments the counter for each received ACK. For these examples, even though the ACKs can be received out of order, out of order receipt does not impact count increments.

In some examples, at 6.6 (Count=Expected ACKs), track logic 576-1 has determined that the counter, following receipt of ACK 1 to ACK n, indicates a count that is equal to or matches the expected number of ACKs for the message.

According to some examples, at 6.7 (Indicate Expected ACKs Received), track logic 576-1 indicates to notification logic 578-1 of network interface controller 172-1 that expected ACKs have been received.

In some examples, at 6.8 (Completion Message), notification logic 578-1 interprets the indication of expected ACKs received as an indication that transmission message of the message to target/responder 120 has been completed and thus a completion message can then be sent to target/responder 120 (e.g., through a source port coupled with a path routed through network 130).

According to some examples, at 6.9 (Completion Notification to Application), responsive to receiving the completion message from notification logic 578-1 at source/initiator 110, notification logic 578-2 at target/responder 120 can cause a completion notification message to be sent to the application at target/responder that was the source of the request to receive the message. Process 600 is done.

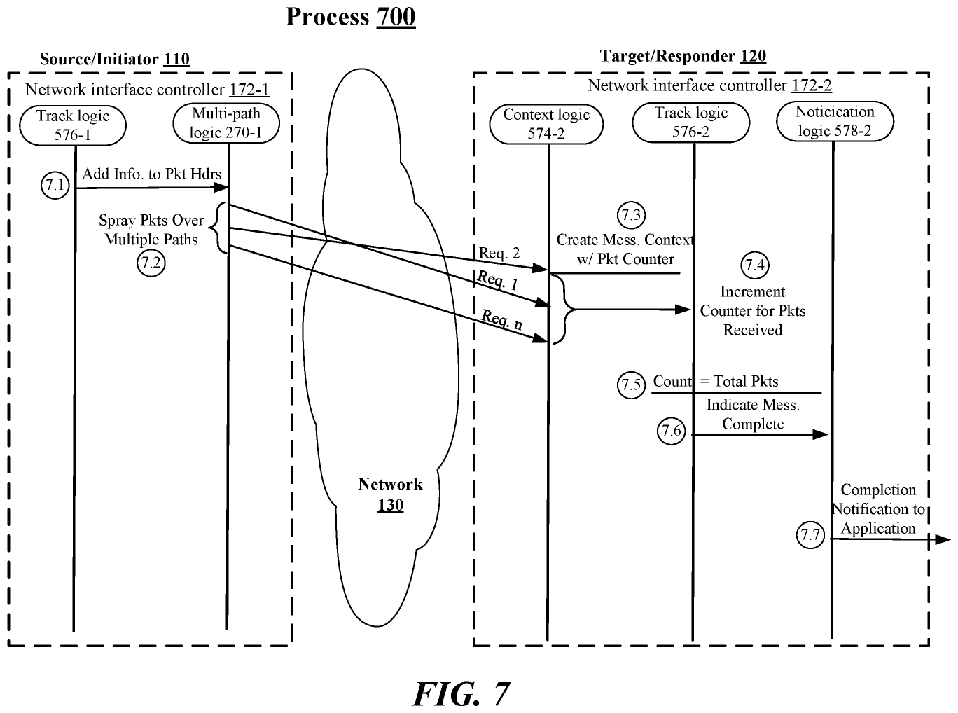

FIG. 7 illustrates an example process 700. In some examples, process 700 can represent techniques to ensure that all packets of a message are received at a target/responder and are globally observable before a notification is to be provided to an application targeted to receive the message. For these examples, the source/initiator is to send packets of the message over multiple path routed through a network to reach a target/responder. For these examples, elements of system 100 as shown in FIG. 1 or 5, can be related to process 700. These elements of system 100 can include source/initiator 110, network interface controller 172-1 and logic supported by circuitry at network interface controller 172-1 such as, but not limited to, track logic 576-1 or multi-path logic 270. The elements of system 100 can also include network 130, target/responder 120, network interface controller 172-2 and logic supported by circuitry at network interface controller 172-2 such as, but not limited to, context logic 574-2, track logic 576-2, or notification logic 578-2. However, example process 700 is not limited to implementations using elements of system 100 shown in FIG. 1 or 5.

According to some examples, at 7.1 (Add Info. to Pkt Hdrs), responsive to a request for source/initiator 110 to send packets of a message to target/responder 120 (e.g., originating from an application at target/responder 120), track logic 576-1 can be arranged to add information to packet headers of the message to allow for either an explicit packet count mechanism or an implicit packet count mechanism at target/responder 120. For example, if an explicit packet count mechanism is being implemented, the added information can include a unique message ID for the message, a unique packet ID for individual packets of the message and a total number of packets for the message. If an implicit packet count mechanism is being implemented, the added information can include a unique message ID for the message, a unique packet ID for individual packets of the message and a total number of packets for the message indicated in at least one packet of the message (e.g., in the first or last packet to be transmitted).

In some examples, at 7.2 (Spray Pkts Over Multiple Paths), multi-path logic 270-1 can cause packets of the message to be sprayed or sent over multiple paths coupled with one or more source ports of network interface controller 172-1. For these examples, the multiple paths are through network 130 (e.g., over paths 132A-C) to target/responder 120. As shown in FIG. 7, Req. 1, Req. 2 and Req. n, for example, can each represent at least one packet or a sub-stream/group of packets transmitted from source/initiator 110 over the multiple paths routed through network 130. Also, Req. 1, Req. 2 to Req. n can represent a sequential ordering of packets in the message.

According to some example, at 7.3 (Create Mess. Context W/Pkt Counter), responsive to receive of at least one packet or group of packets received by target/responder 120 for the message, context logic 574-2 can create a message context that includes a packet counter.

In some examples, at 7.4 (Increment Counter for Pkts Received), responsive to each received Req. via one of multiple destination ports of network interface controller 172-2 coupled with one of path 132A-C, track logic 576-2 of network interface controller 172-2 at target/responder 120 can increment the packet counter of the message context based on packets included in received Reqs. For these examples, separate ACKs can be sent on the same path via which a Req. was received, but these ACKs are not shown in FIG. 7 for simplicity purposes. Similar to what was mentioned above for process 600, according to some examples, the path used to route Req. 1 can cause a delay that results in Req. 2 being received before/out of order compared to receipted of Req. 1. Since the packet counter has been incremented for packets received, an out of order receipt of packets of the message does not impact count increments.

In some examples, at 7.5 (Count=Total Pkts), track logic 576-2 has determined that the packet counter included in the message context, following receipt of Req. n, indicates a count that is equal to or matches the total packet count for the message. For an explicit packet count mechanism, the total packet count can be indicated in headers of the received packet of the message. For an implicit packet count mechanism, the total packet count can be indicated in a header of at least one received packet of the message.

According to some examples, at 7.6 (Indicate Mess. Complete), track logic 576-2 indicates a message completion to notification logic 578-2 responsive to determining that packets of the message have been received based on the incremented counter matching the total packets indicated in at least one header of the received packets.

According to some examples, at 7.7 (Completion Notification to Application), responsive to receiving the message complete indication from track logic 576-2, notification logic 578-2 can cause a completion notification message to be sent to the application at target/responder that was the source of the request to receive the message. Process 700 is done.

Although process 600 and process 700 each indicate that completion notifications can be directed to an application at target/responder 120 following a determination that packets of a message have been received at target/responder, examples are not limited to sending completion notification to an application at target/responder 120. For example, a completion notification can also be sent to an application at source/initiator 110 to indicate that all packets for a message that may have been caused to be sent to target/responder 120 responsive to the application at source/initiator 110.

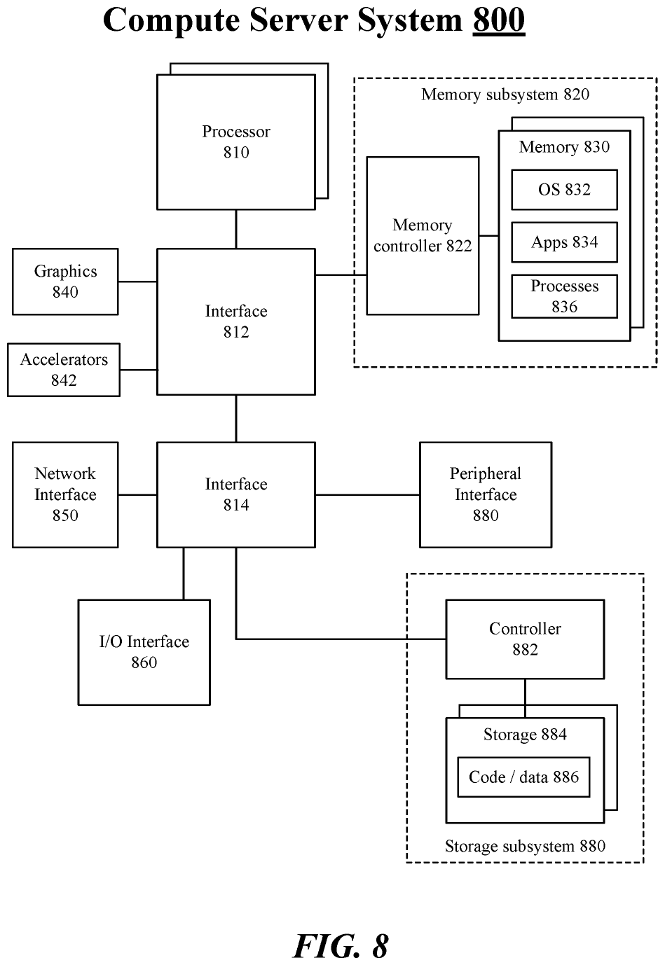

FIG. 8 illustrates an example system 800. In some examples, multi-path reliability and/or completion reporting techniques for transmitting/receiving packets of a message can be performed, as described herein. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some embodiments, in addition or alternatively, an accelerator among accelerators 842 provides field select controller capabilities as described herein. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices of memory 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 technology to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU).

In some examples, lookups for entries using LPM and exact match can be performed for packets using programmable pipelines of network interface 850, as described herein.

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 800 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example can be implemented by representative instructions stored on at least one machine-readable medium which represents various logic within the processor, which when read by a machine, computing device or system causes the machine, computing device or system to fabricate logic to perform the techniques described herein. Such representations, known as “IP cores” can be stored on a tangible, machine readable medium and supplied to various customers or manufacturing facilities to load into the fabrication machines that actually make the logic or processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples can include an article of manufacture or at least one computer-readable medium. A computer-readable medium can include a non-transitory storage medium to store logic. In some examples, the non-transitory storage medium can include one or more types of computer-readable storage media capable of storing electronic data, including volatile memory or non-volatile memory, removable or non-removable memory, erasable or non-erasable memory, writeable or re-writeable memory, and so forth. In some examples, the logic can include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium can include a non-transitory storage medium to store or maintain instructions that when executed by a machine, computing device or system, cause the machine, computing device or system to perform methods and/or operations in accordance with the described examples. The instructions can include any suitable type of code, such as source code, compiled code, interpreted code, executable code, static code, dynamic code, and the like. The instructions can be implemented according to a predefined computer language, manner or syntax, for instructing a machine, computing device or system to perform a certain function. The instructions can be implemented using any suitable high-level, low-level, object-oriented, visual, compiled and/or interpreted programming language.

Some examples can be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples can be described using the expression “coupled” and “connected” along with their derivatives. These terms are not necessarily intended as synonyms for each other. For example, descriptions using the terms “connected” and/or “coupled” can indicate that two or more elements are in direct physical or electrical contact with each other. The term “coupled” or “coupled with”, however, can also mean that two or more elements are not in direct contact with each other, but yet still co-operate or interact with each other.

The following examples pertain to additional examples of technologies disclosed herein.

Example 1. An example network interface controller can include one or more destination ports to couple with a plurality of paths through a network to a source of a message. The network interface controller can also include circuitry, the circuitry can be configured to receive multiple sub-streams of a data stream of a message through the one or more destination ports. The circuitry can also be configured to check information included in headers of one or more packets included in the multiple sub-streams to determine if packets included in respective sub-streams of the multiple sub-streams have been received, the checked information to include sub-stream specific sequence numbers.

Example 2. The network interface controller of example 1, to determine if packets included in respective sub-streams of the multiple sub-streams have been received can be based on no missing sequence numbers for packets of received sub-streams according to the sub-stream specific sequence numbers.

Example 3. The network interface controller of example 1, the packets included in the multiple sub-streams can be formatted as RDMA packets.

Example 4. The network interface controller of example 1, the circuitry can also be configured to merge the multiple sub-streams to recreate the data stream of the message based on packets in respective sub-streams of the multiple sub-streams being determined as received.

Example 5. The network interface controller of example 1, the circuitry can also be configured to create a message context for the message responsive to receipt of a first packet of a first sub-stream of the multiple sub-streams through a destination port from among the one or more destination ports, the message context to include a packet counter. The circuitry can also be configured to increment the packet counter for individual packets included in the multiple sub-streams received through the one or more destination ports. The circuitry can also be configured to determine that packets for the message have been received responsive to a count value of the incremented packet counter matching a total packet number indicated in information included in at least one header of a received packet. The circuitry can also be configured to send a completion notification to an application to indicate the message has been received.

Example 6. The network interface controller of example 5, information included in headers of received packets can indicate a unique message identifier for the message, a unique packet identifier for a respectively received packet and the total packet number. The message context can be associated with the unique message identifier in order to track received packets for the message.

Example 7. The network interface controller of example 5, information included in headers of received packets can indicate a unique message identifier for the message, a unique packet identifier for a respectively received packet. The message context can to be associated with the unique message identifier in order to track received packets for the message, and a single packet of the message an indicate the total packet number.

Example 8. The network interface controller of example 1, sub-streams of the multiple sub-streams can be sent through different source ports at the source of the message, the different source ports separately coupled with different paths from among the plurality of paths.

Example 9. An example method can include receiving multiple sub-streams of a data stream of a message via a plurality of paths through a network. The method can also include checking information included in headers of one or more packets included in the multiple sub-streams to determine if packets included in respective sub-streams of the multiple sub-streams have been received. The checked information can include sub-stream specific sequence numbers.

Example 10. The method of example 9, to determine if packets included in respective sub-streams of the multiple sub-streams have been received can be based on no missing sequence numbers for packets of received sub-streams according to the sub-stream specific sequence numbers.

Example 11. The method of example 9, the packets included in the multiple sub-streams can be formatted as RDMA packets.

Example 12. The method of example 9 can also include merging the multiple sub-streams to recreate the data stream of the message based on packets in respective sub-streams of the multiple sub-streams being determined as received.

Example 13. The method of example 9 can also include creating a message context for the message responsive to receipt of a first packet of a first sub-stream of the multiple sub-streams through a destination port from among the one or more destination ports, the message context to include a packet counter. The method can also include incrementing the packet counter for individual packets included in the multiple sub-streams received through the one or more destination ports. The method can also include determining that packets for the message have been received responsive to a count value of the incremented packet counter matching a total packet number indicated in information included in at least one header of a received packet. The method can also include sending a completion notification to an application to indicate the message has been received.

Example 14. The method of example 13, information included in headers of received packets can indicate a unique message identifier for the message, a unique packet identifier for a respectively received packet and the total packet number. The message context can be associated with the unique message identifier in order to track received packets for the message.

Example 15. The method of example 13, the information included in headers of received packets can indicate a unique message identifier for the message, a unique packet identifier for a respectively received packet. The message context can be associated with the unique message identifier in order to track received packets for the message. A single packet of the message can indicate the total packet number.

Example 16. The method of example 9, sub-streams of the multiple sub-streams can be sent through different source ports at the source of the message, the different source ports separately coupled with different paths from among the plurality of paths.

Example 17. An example at least one machine readable medium can include a plurality of instructions that in response to being executed by a circuitry at a network interface controller can cause the circuitry to receive multiple sub-streams of a data stream of a message via a plurality of paths through a network. The instructions can also cause the circuitry to check information included in headers of one or more packets included in the multiple sub-streams to determine if packets included in respective sub-streams of the multiple sub-streams have been received. The checked information can include sub-stream specific sequence numbers.

Example 18. The at least one machine readable medium of example 17, to determine if packets included in respective sub-streams of the multiple sub-streams have been received can be based on no missing sequence numbers for packets of received sub-streams according to the sub-stream specific sequence numbers.

Example 19. The at least one machine readable medium of example 17, the packets included in the multiple sub-streams can be formatted as RDMA packets.

Example 20. The at least one machine readable medium of example 17, the instructions can further cause the circuitry to merge the multiple sub-streams to recreate the data stream of the message based on packets in respective sub-streams of the multiple sub-streams being determined as received.

Example 21. The at least one machine readable medium of example 17, the instructions can further cause the circuitry to create a message context for the message responsive to receipt of a first packet of a first sub-stream of the multiple sub-streams through a destination port from among the one or more destination ports, the message context to include a packet counter. The instructions can also cause the circuitry to increment the packet counter for individual packets included in the multiple sub-streams received through the one or more destination ports. The instructions can also cause the circuitry to determine that packets for the message have been received responsive to a count value of the incremented packet counter matching a total packet number indicated in information included in at least one header of a received packet. The instructions can also cause the circuitry to send a completion notification to an application to indicate the message has been received.

Example 22. The at least one machine readable medium of example 21, information included in headers of received packets can indicate a unique message identifier for the message, a unique packet identifier for a respectively received packet and the total packet number. The message context can be associated with the unique message identifier in order to track received packets for the message.

Example 23. The at least one machine readable medium of example 21, information included in headers of received packets can indicate a unique message identifier for the message, a unique packet identifier for a respectively received packet. The message context can be associated with the unique message identifier in order to track received packets for the message, and a single packet of the message can indicate the total packet number.

Example 24. The at least one machine readable medium of example 17, the sub-streams of the multiple sub-streams can be sent through different source ports at the source of the message, the different source ports separately coupled with different paths from among the plurality of paths.

Example 25. An example network interface controller can include multiple source ports to couple with a plurality of paths to be routed through a network to a target. The network interface controller can also include circuitry that can be configured to receive a request to send a message in a data stream through a network to a target. The circuitry can also be configured to create multiple sub-streams of the data stream, sub-streams of the multiple sub-streams to separately include a group of packets, the multiple sub-streams created based on adding header information to packets of a sub-stream that indicate a source port from which the sub-stream is to be transmitted. Sub-streams of the multiple sub-streams can be transmitted through different source ports. The circuitry can also be configured to add additional header information to packets of a sub-stream to facilitate a determination at the target of whether packets included in the sub-streams of the multiple sub-streams have been received. The circuitry can also be configured to cause the sub-streams to be transmitted through the different indicated source ports in order to route the sub-streams through the network over multiple paths coupled to the target.

Example 26. The network interface controller of example 25, the additional header information added to packets can include adding separate sets of sequence numbers to headers of packets included in respective groups of packets in order to facilitate the determination at the target of whether packets included in sub-streams of the multiple sub-streams have been received.

Example 27. The network interface controller of example 25, packets included in the multiple sub-streams can be formatted as RDMA packets.

Example 28. The network interface controller of example 25, the circuitry can also be configured to determine an expected number of ACKs to be received from the target based on the sub-streams to be transmitted through the different indicated source ports in order to route the sub-streams through the network over multiple paths coupled to the target. The circuitry can also be configured to increment a counter responsive to receiving respective ACKs from the target that separately indicate receipt of respectively transmitted sub-streams. The circuitry can also be configured to send a message completion indication to the target responsive to a count value of the incremented counter matching the expected number of ACKs.

Example 29. An example method can include receiving a request to send a message in a data stream through a network to a target. The method can also include creating multiple sub-streams of the data stream, sub-streams of the multiple sub-streams to separately include a group of packets, the multiple sub-streams created based on adding header information to packets of a sub-stream that indicate a source port from which the sub-stream is to be transmitted. Sub-streams of the multiple sub-streams can be transmitted through different source ports. The method can also include adding additional header information to packets of a sub-stream to facilitate a determination at the target of whether packets included in the sub-streams of the multiple sub-streams have been received. The method can also include causing the sub-streams to be transmitted through the different indicated source ports in order to route the sub-streams through the network over multiple paths coupled to the target.

Example 30. The method of example 29, the additional header information added to packets can include adding separate sets of sequence numbers to headers of packets included in respective groups of packets in order to facilitate the determination at the target of whether packets included in sub-streams of the multiple sub-streams have been received.

Example 31. The method of example 29, packets included in the multiple sub-streams can be formatted as RDMA packets.

Example 32. The method of example 29 can also include determining an expected number of ACKs to be received from the target based on the sub-streams to be transmitted through the different indicated source ports in order to route the sub-streams through the network over multiple paths coupled to the target. The method can also include incrementing a counter responsive to receiving respective ACKs from the target that separately indicate receipt of respectively transmitted sub-streams. The method can also include sending a message completion indication to the target responsive to a count value of the incremented counter matching the expected number of ACKs.

Example 33. An example at least one machine readable medium can include a plurality of instructions that in response to being executed by a circuitry at a network interface controller can cause the circuitry to receive a request to send a message in a data stream through a network to a target. The instructions can also cause the circuitry to create multiple sub-streams of the data stream, sub-streams of the multiple sub-streams to separately include a group of packets, the multiple sub-streams created based on adding header information to packets of a sub-stream that indicate a source port from which the sub-stream is to be transmitted. Sub-streams of the multiple sub-streams can be transmitted through different source ports. The instructions can also cause the circuitry to add additional header information to packets of a sub-stream to facilitate a determination at the target of whether packets included in the sub-streams of the multiple sub-streams have been received. The instructions can also cause the circuitry to cause the sub-streams to be transmitted through the different indicated source ports in order to route the sub-streams through the network over multiple paths coupled to the target.

Example 34. The at least one machine readable medium of example 33, the additional header information added to packets can include adding separate sets of sequence numbers to headers of packets included in respective groups of packets in order to facilitate the determination at the target of whether packets included in sub-streams of the multiple sub-streams have been received.

Example 35. The at least one machine readable medium of example 33, packets included in the multiple sub-streams can be formatted as RDMA packets.

Example 36. The at least one machine readable medium of example 33, the instructions can further cause the circuitry to determine an expected number of ACKs to be received from the target based on the sub-streams to be transmitted through the different indicated source ports in order to route the sub-streams through the network over multiple paths coupled to the target The instructions can also cause the circuitry to increment a counter responsive to receiving respective ACKs from the target that separately indicate receipt of respectively transmitted sub-streams. The instructions can also cause the circuitry to send a message completion indication to the target responsive to a count value of the incremented counter matching the expected number of ACKs.

Example 37. An example system can include a network to include a plurality of paths configured to route packets. The system can also include a source network interface controller to couple to the plurality of paths through one or more source ports. The system can also include a destination network interface controller to include one or more destination ports to couple with a plurality of paths and circuitry. The circuitry at the destination network interface controller can be configured to receive multiple sub-streams of a data stream of a message through the one or more destination ports. The circuitry can also be configured to check information included in headers of one or more packets included in the multiple sub-streams to determine if packets included in respective sub-streams of the multiple sub-streams have been received. The checked information can include sub-stream specific sequence numbers.

Example 38. The system of example 37, to determine if packets included in respective sub-streams of the multiple sub-streams have been received can be based on no missing sequence numbers for packets of received sub-streams according to the sub-stream specific sequence numbers.

Example 39. The system of example 37, the packets included in the multiple sub-streams can be formatted as RDMA packets.

Example 40. The system of example 37, the circuitry at the destination network interface controller can also merge the multiple sub-streams to recreate the data stream of the message based on packets in respective sub-streams of the multiple sub-streams being determined as received.

Example 41. The system of example 37, the circuitry at the destination network interface controller can also create a message context for the message responsive to receipt of a first packet of a first sub-stream of the multiple sub-streams through a destination port from among the one or more destination ports, the message context to include a packet counter. The circuitry can also increment the packet counter for individual packets included in the multiple sub-streams received through the one or more destination ports. The circuitry can also determine that packets for the message have been received responsive to a count value of the incremented packet counter matching a total packet number indicated in information included in at least one header of a received packet. The circuitry can also send a completion notification to an application to indicate the message has been received.

Example 42. The system of example 41, information included in headers of received packets can indicate a unique message identifier for the message, a unique packet identifier for a respectively received packet and the total packet number, wherein the message context is to be associated with the unique message identifier in order to track received packets for the message.

Example 43. The system of example 41, information included in headers of received packets can indicate a unique message identifier for the message, a unique packet identifier for a respectively received packet, wherein the message context is to be associated with the unique message identifier in order to track received packets for the message. A single packet of the message can indicate the total packet number.

Example 44. The system of example 37, sub-streams of the multiple sub-streams can be sent through different source ports at the source of the message, the different source ports separately coupled with different paths from among the plurality of paths.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, can be used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An network interface controller comprising:
one or more destination ports to couple with a plurality of paths through a network to a source of a message; and
circuitry to be configured to:
receive multiple sub-streams of a data stream of a message through the one or more destination ports; and
check information included in headers of one or more packets included in the multiple sub-streams to determine if packets included in respective sub-streams of the multiple sub-streams have been received, the checked information to include sub-stream specific sequence numbers.

2. The network interface controller of claim 1, wherein to determine if packets included in respective sub-streams of the multiple sub-streams have been received is based on no missing sequence numbers for packets of received sub-streams according to the sub-stream specific sequence numbers.

3. The network interface controller of claim 1, wherein the packets included in the multiple sub-streams are formatted as remote direct memory access (RDMA) packets.

4. The network interface controller of claim 1, further comprising the circuitry to:
merge the multiple sub-streams to recreate the data stream of the message based on packets in respective sub-streams of the multiple sub-streams being determined as received.

5. The network interface controller of claim 1, further comprising the circuitry to:
create a message context for the message responsive to receipt of a first packet of a first sub-stream of the multiple sub-streams through a destination port from among the one or more destination ports, the message context to include a packet counter;
increment the packet counter for individual packets included in the multiple sub-streams received through the one or more destination ports;
determine that packets for the message have been received responsive to a count value of the incremented packet counter matching a total packet number indicated in information included in at least one header of a received packet; and
send a completion notification to an application to indicate the message has been received.

6. The network interface controller of claim 5, information included in headers of received packets indicate a unique message identifier for the message, a unique packet identifier for a respectively received packet and the total packet number, wherein the message context is to be associated with the unique message identifier in order to track received packets for the message.

7. The network interface controller of claim 5, information included in headers of received packets indicate a unique message identifier for the message, a unique packet identifier for a respectively received packet, wherein the message context is to be associated with the unique message identifier in order to track received packets for the message, and wherein a single packet of the message indicates the total packet number.

8. The network interface controller of claim 1, wherein sub-streams of the multiple sub-streams are to be sent through different source ports at the source of the message, the different source ports separately coupled with different paths from among the plurality of paths.

9. At least one machine readable medium comprising a plurality of instructions that in response to being executed by a circuitry at a network interface controller cause the circuitry to:
receive multiple sub-streams of a data stream of a message via a plurality of paths through a network; and
check information included in headers of one or more packets included in the multiple sub-streams to determine if packets included in respective sub-streams of the multiple sub-streams have been received, the checked information to include sub-stream specific sequence numbers.

10. The at least one machine readable medium of claim 9, wherein to determine if packets included in respective sub-streams of the multiple sub-streams have been received is based on no missing sequence numbers for packets of received sub-streams according to the sub-stream specific sequence numbers.

11. The at least one machine readable medium of claim 9, wherein in the instructions further cause the circuitry to:
merge the multiple sub-streams to recreate the data stream of the message based on packets in respective sub-streams of the multiple sub-streams being determined as received.

12. The at least one machine readable medium of claim 9, wherein the instructions further cause the circuitry to:
create a message context for the message responsive to receipt of a first packet of a first sub-stream of the multiple sub-streams, the message context to include a packet counter;
increment the packet counter for individual packets included in the received sub-streams;
determine that packets for the message have been received responsive to a count value of the incremented packet counter matching a total packet number indicated in information included in at least one header of a received packet; and
send a completion notification to an application to indicate the message has been received.

13. The at least one machine readable medium of claim 12, information included in headers of received packets indicate a unique message identifier for the message, a unique packet identifier for a respectively received packet and the total packet number, wherein the message context is to be associated with the unique message identifier in order to track received packets for the message.

14. The at least one machine readable medium of claim 12, information included in headers of received packets indicate a unique message identifier for the message, a unique packet identifier for a respectively received packet, wherein the message context is to be associated with the unique message identifier in order to track received packets for the message, and wherein a single packet of the message indicates the total packet number.

15. At least one machine readable medium comprising a plurality of instructions that in response to being executed by a circuitry at a network interface controller cause the circuitry to:
receive a request to send a message in a data stream through a network to a target;
create multiple sub-streams of the data stream, sub-streams of the multiple sub-streams to separately include a group of packets, the multiple sub-streams created based on adding header information to packets of a sub-stream that indicate a source port from which the sub-stream is to be transmitted, wherein sub-streams of the multiple sub-streams are to be transmitted through different source ports;
add additional header information to packets of a sub-stream to facilitate a determination at the target of whether packets included in the sub-streams of the multiple sub-streams have been received; and
cause the sub-streams to be transmitted through the different indicated source ports in order to route the sub-streams through the network over multiple paths coupled to the target.

16. The at least one machine readable medium of claim 15, wherein the additional header information added to packets includes adding separate sets of sequence numbers to headers of packets included in respective groups of packets in order to facilitate the determination at the target of whether packets included in sub-streams of the multiple sub-streams have been received.

17. The at least one machine readable medium of claim 15, wherein packets included in the multiple sub-streams are formatted as remote direct memory access (RDMA) packets.

18. The at least one machine readable medium of claim 15, the instructions to further cause the circuitry to:
determine an expected number of acknowledgements (ACKs) to be received from the target based on the sub-streams to be transmitted through the different indicated source ports in order to route the sub-streams through the network over multiple paths coupled to the target;
increment a counter responsive to receiving respective ACKs from the target that separately indicate receipt of respectively transmitted sub-streams; and
send a message completion indication to the target responsive to a count value of the incremented counter matching the expected number of ACKs.

19. A system comprising:
a network to include a plurality of paths configured to route packets;
a source network interface controller to couple to the plurality of paths through one or more source ports; and
a destination network interface controller to include one or more destination ports to couple with a plurality of paths and circuitry, the circuitry configured to:
receive multiple sub-streams of a data stream of a message through the one or more destination ports; and
check information included in headers of one or more packets included in the multiple sub-streams to determine if packets included in respective sub-streams of the multiple sub-streams have been received, the checked information to include sub-stream specific sequence numbers.

20. The system of claim 19, wherein to determine if packets included in respective sub-streams of the multiple sub-streams have been received is based on no missing sequence numbers for packets of received sub-streams according to the sub-stream specific sequence numbers.

21. The system of claim 19, further comprising the circuitry at the destination network interface controller to:
merge the multiple sub-streams to recreate the data stream of the message based on packets in respective sub-streams of the multiple sub-streams being determined as received.

22. The system of claim 19, further comprising the circuitry at the destination network interface controller to:
create a message context for the message responsive to receipt of a first packet of a first sub-stream of the multiple sub-streams through a destination port from among the one or more destination ports of the destination network interface controller, the message context to include a packet counter;
increment the packet counter for individual packets included in the multiple sub-streams received through the one or more destination ports of the destination network interface controller;
determine that packets for the message have been received responsive to a count value of the incremented packet counter matching a total packet number indicated in information included in at least one header of a received packet; and
send a completion notification to an application to indicate the message has been received.

23. The system of claim 22, information included in headers of received packets indicate a unique message identifier for the message, a unique packet identifier for a respectively received packet and the total packet number, wherein the message context is to be associated with the unique message identifier in order to track received packets for the message.

24. The system of claim 22, information included in headers of received packets indicate a unique message identifier for the message, a unique packet identifier for a respectively received packet, wherein the message context is to be associated with the unique message identifier in order to track received packets for the message, and wherein a single packet of the message indicates the total packet number.

25. The system of claim 19, wherein sub-streams of the multiple sub-streams are to be sent through different source ports of the source network interface controller, the different source ports separately coupled with different paths from among the plurality of paths configured to route packets.
